(19) United States
(12) Patent Application Publication
(10) Pub. No.: US 2022/0366204 A1
(43) Pub. Date: Nov. 17, 2022

(54) CHIP CARD BIOMETRIC SENSOR COMPONENT

(71) Applicant: Infineon Technologies AG, Neubiberg (DE)

(72) Inventors: Frank Pueschner, Kelheim (DE); Jens Pohl, Bernhardswald (DE); Peter Stampka, Burglengenfeld (DE)

(21) Appl. No.: 17/742,873

(22) Filed: May 12, 2022

(30) Foreign Application Priority Data
May 12, 2021 (DE) 102021112447.6

(51) Int. Cl. G06K 19/07

(52) U.S. Cl. CPC G06K 19/0718

(57) ABSTRACT

A chip card biometric sensor component having a carrier, a biometric sensor arranged on or in the carrier, a control logic, which is arranged on or in the carrier and is coupled to the biometric sensor, and at least one light-emitter, which is arranged on or in the carrier or in an opening of the carrier and is connected to the control logic and is controllable by the latter.

### TECHNICAL FIELD

The disclosure relates to a chip card biometric sensor component, to a chip card, to a method for forming a chip card biometric sensor component, and to a method for forming a chip card.

### BACKGROUND

Chip cards for a contactless application and for an alternative or additional contact-based application are sometimes equipped with biometric sensors, e.g., fingerprint sensors.

Some of these chip cards are additionally equipped with light-emitting diodes (LEDs). The latter are typically integrated into the card body, which means increased complexity in terms of mounting and connection of the LED.

### BRIEF DESCRIPTION OF THE DRAWINGS

Exemplary aspects of the disclosure are illustrated in the figures and are explained in more detail below.

In the figures:

FIG. 1 shows schematic perspective illustrations of a chip card biometric sensor component according to various exemplary aspects;

FIG. 2 shows schematic perspective illustrations of an LED element for use in a chip card biometric sensor component according to various exemplary aspects;

FIG. 3 shows an illustration of a mounting of an LED element in a chip card biometric sensor component according to various exemplary aspects;

FIG. 4 shows a schematic perspective illustration of a chip card according to various exemplary aspects;

FIG. 5 shows a flowchart of a method for forming a chip card biometric sensor component according to various exemplary aspects; and

FIG. 6 shows a flowchart of a method for forming a chip card according to various exemplary aspects.

### DETAILED DESCRIPTION

In the following detailed description, reference is made to the accompanying drawings which form part of said description and show, for illustration, specific aspects in which the disclosure can be performed. In this respect, direction terminology, for instance “at the top”, “at the bottom”, “at the front”, “at the rear”, “front”, “rear”, etc., is used with reference to the orientation of the described figure(s). Since components of aspects can be positioned in a number of different orientations, the direction terminology is used for illustration and is not restrictive in any way. It goes without saying that other aspects can be used and structural or logical changes can be made without departing from the scope of protection of the present disclosure. It goes without saying that the features of the various exemplary aspects described herein can be combined with one another, unless specifically stated otherwise. The following detailed description therefore should not be interpreted in a restrictive sense, and the scope of protection of the present disclosure is defined by the attached claims.

Within the scope of this description, the terms “linked,” “connected,” and “coupled” are used to describe both a direct and an indirect link, a direct or indirect connection, and a direct or indirect coupling. In the figures, identical or similar elements are provided with identical reference signs if expedient.

In various exemplary aspects, a chip card biometric sensor component is provided, which not only comprises the biometric sensor but additionally also a light-emitting means, e.g., an LED.

It is possible in this way to avoid that the light-emitting means needs to be integrated into the chip card body and thus the chip card biometric sensor component including the light-emitting means is mountable by means of a standard 35 mm roll-to-roll method, which is typically performed on the part of the customer.

The chip card biometric sensor component can be integrated for use in a contactless chip card, in a contact-based chip card or in what is known as a dual interface chip card, that is to say a chip card that allows both contactless and also contact-based use.

The chip card biometric sensor component can have a contact-based interface, which can have, for example, ISO 7816 contact surfaces, and/or a contactless interface, which can have for example an antenna (as what is known as a coil-on module (CoMs) antenna), which can be for coupling to what is known as a booster antenna integrated in the card body of the chip card.

In various exemplary aspects, the light-emitting means can be or include at least one LED, for example one or more LEDs.

The chip card biometric sensor component can have a control logic that can be, for example, a part of an IC chip. The control logic can be configured for controlling the biometric sensor.

Furthermore, the control logic can be configured for controlling the light-emitting means.

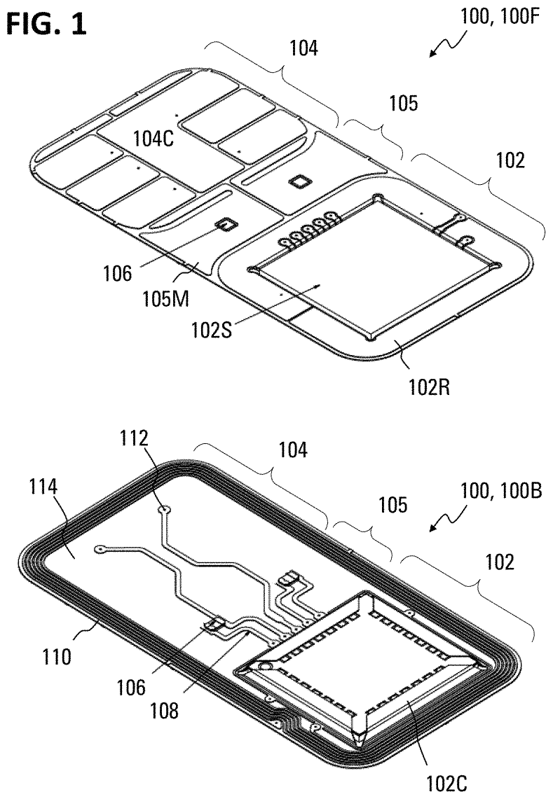

FIG. 1 shows schematic perspective illustrations of an upper side or front side 100F (top) and a lower side or back side 100B of a chip card biometric sensor component 100 according to various exemplary aspects.

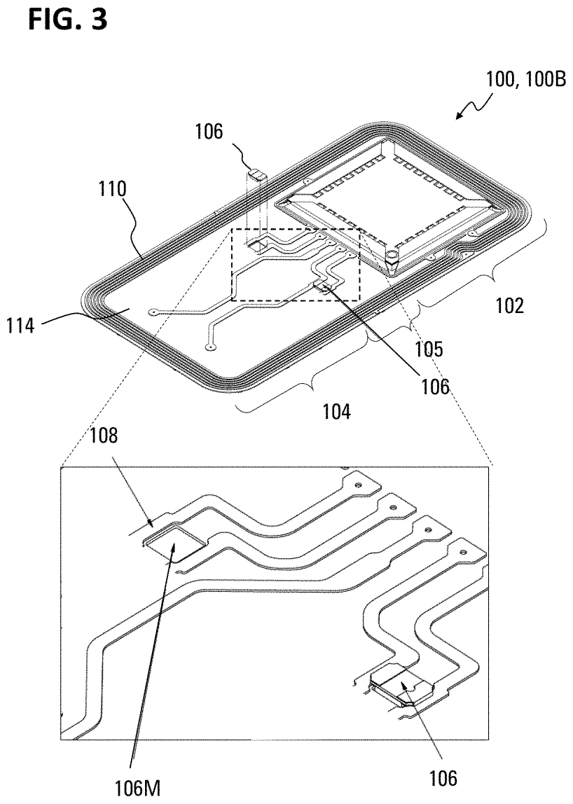

The chip card biometric sensor component 100 has at least one light-emitting means (two light-emitting means in each case by way of example in FIG. 1 and FIG. 3).

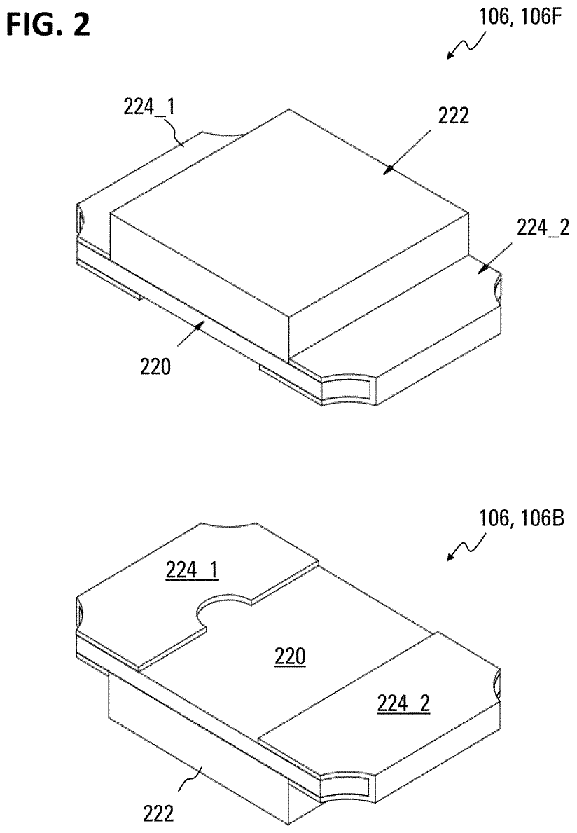

FIG. 2 shows schematic perspective illustrations of an LED element 106 as an exemplary light-emitting means for use in a chip card biometric sensor component 100 according to various exemplary aspects.

FIG. 3 illustrates how the LED element from FIG. 2 can be mounted in a chip card biometric sensor component 100 according to various exemplary aspects.

The chip card biometric sensor component 100 can have a carrier 114, for example an electrically insulating carrier, for example a polymer such as for example polyimide, or another carrier material known from the prior art. The carrier 114 can be formed for example as a carrier strip, for example a standard 35 mm carrier strip.

In various exemplary aspects, the chip card biometric sensor component 100 can have a biometric sensor 102, for example a fingerprint sensor, arranged on or in the carrier 114.

The biometric sensor 102 can have an exposed sensor surface 102S, which can be provided for the purpose of being touched for capturing biometric features, for example touched with a surface of a finger.

In various exemplary aspects, the sensor surface 102S can be surrounded by a metal surface 102R, which is formed so as to be annular, for example, can be connected to ground potential, and can serve as protection against electrostatic charge, in that the metal surface 102R is touched more or less automatically when the sensor surface 102S is being touched.

The chip card biometric sensor component 100 can have a control logic, which is arranged on or in the carrier 114 and is coupled to the biometric sensor 102. For example, the control logic can be a part of a chip, for example of a secure element, as is typically used in connection with biometric sensors. The control logic can be integrated for example in the sensor 102. Alternatively, the control logic can be arranged at a different location of the chip card biometric sensor component 100.

The chip card biometric sensor component 100 can have at least one light-emitting means 106, which is arranged on or in the carrier 114 or in an opening 106M of the carrier 114 and is connected to the control logic and is controllable by the latter.

The control logic can be connected to the at least one light-emitting means 106 by means of electrically conductive connections 108.

The at least one light-emitting means 106 can include, for example, one or more light-emitting diodes (LEDs). If only one light-emitting means 106 is present, the light-emitting means 106 can indicate for example a correct electrically conductive contact and/or a malfunction. If a plurality of light-emitting means 106 are provided (for example two, as in the exemplary aspect of FIGS. 1 and 3), the light-emitting means 106 can be controlled differently, for example one of the light-emitting means 106 can be switched on in the case of a correct function (for example in the event of a successful authentication), and the other light-emitting means 106 can be switched on in the event of a malfunction (for example if authentication has failed).

Optionally, the light-emitting means 106 can have different colors. It is also possible to use a light-emitting means that emits different colors depending on the wiring.

The chip card biometric sensor component 100 can furthermore have a contactless interface 110, which is coupled to the control logic, for example an antenna, which can be configured for contactless communication, for example in that the antenna (as a CoM) can couple to a booster antenna that can be integrated in a chip card body.

The antenna can be arranged for example on the lower side of the chip card biometric sensor component 100 or at another useful position.

Alternatively or additionally, the chip card biometric sensor component 100 can have contact surfaces 104C, e.g., ISO 7816 contact surfaces, for contact-based communication (the entire contact-based component is denoted by 104).

In various exemplary aspects, the at least one light-emitting means 106 can be arranged between the contact surfaces 104C and the biometric sensor 102. This is illustrated, by way of example, in FIG. 1 and FIG. 3. The corresponding region 105 of the chip card biometric sensor component 100 is marked in FIG. 1 and FIG. 3.

The arrangement between the contact surfaces 104C and the biometric sensor 102 can be advantageous to the extent that the biometric sensor 102 is provided for being used from a side lying opposite the contact surfaces 104C. For example, the finger can be placed thereon from that side. In this way, the region between the biometric sensor 102 and the contact surfaces 104C is exposed, and the light-emitting means 106 are therefore not covered. Furthermore, lines 108 can already extend from the contact surfaces 104C to the biometric sensor 102 and be at least partially used to connect the at least one light-emitting means 106. Placement between the biometric sensor 102 and the contact surfaces 104C can furthermore be more space-saving than other designs. The connections shown in FIG. 1 and FIG. 3 should be understood to be examples. The at least one light-emitting means 106 should be connected to the control circuit such that it is appropriately operable.

In various exemplary aspects, the at least one light-emitting means 106 can be placed at a different location.

In various exemplary aspects, a metal layer 105M can be formed in the light-emitting means region 105, for example by way of the same process that is used for forming the contact surfaces 104C. The metal layer 105M can have cutouts 106M, in which the respective light-emitting means 106 can be arranged. The metal layer 105M can provide mechanical protection for the light-emitting means 106, for example in an event that the light-emitting means 106 projects from the carrier 114 to the front side 100F. In various exemplary aspects, the light-emitting means 106 can be positioned in the carrier 114, e.g., the through opening 106M, such that a front-side surface of the light-emitting means 106 terminates flush with a surface of the carrier 114 or lies below it.

The light-emitting means 106 can, depending on the design, be placed in a through opening 106M of the carrier 114 or be arranged on the carrier 114 or be formed or arranged in the carrier 114. The light-emitting means 106 can be exposed or be covered only by transparent or translucent materials, with the result that any illumination is visible on the front side 100F of the chip card biometric sensor component 100.

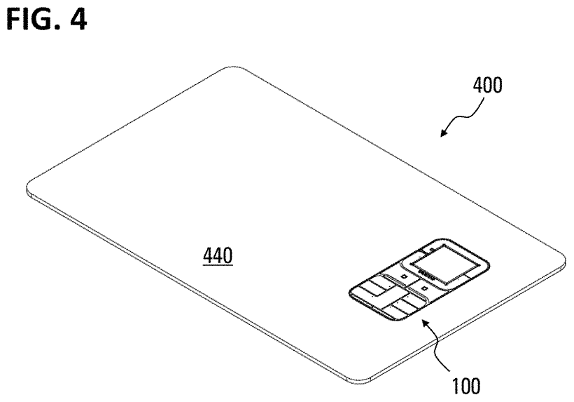

FIG. 4 shows a schematic perspective illustration of a chip card 400 according to various exemplary aspects.

The chip card 400 has a chip card body 440, in which a chip card biometric sensor component 100 according to various exemplary aspects is arranged, for example one of the above-described chip card biometric sensor components 100.

Providing the chip card 400 with the biometric sensor 102 and the at least one light-emitting means 106 can be particularly simple to the extent that the chip card biometric sensor component 100 is easily insertable into an opening formed in the chip card body 440. The process of forming the chip card 400 can thus take place substantially in a way that is known from the prior art. The forming of a booster antenna in the chip card body 440 can substantially also take place in a way that is known from the prior art.

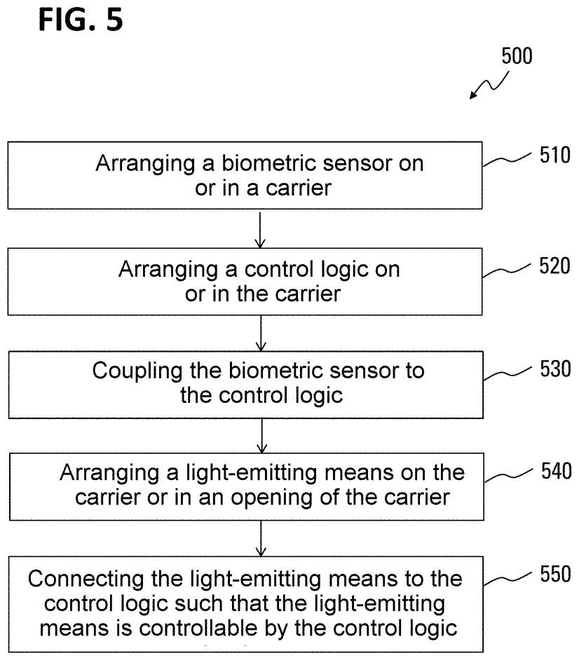

FIG. 5 shows a flowchart 500 of a method for forming a chip card biometric sensor component according to various exemplary aspects.

The method comprises arranging a biometric sensor on or in a carrier (510), arranging a control logic on or in the carrier (520), coupling the biometric sensor to the control logic (530), arranging at least one light-emitting means on the carrier or in an opening of the carrier (540), and connecting the light-emitting means to the control logic, so that the light-emitting means is controllable by the control logic (550).

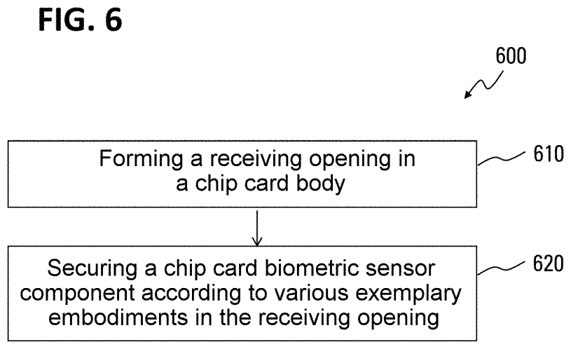

FIG. 6 shows a flowchart 600 of a method for forming a chip card according to various exemplary aspects.

The method comprises forming a receiving opening in a chip card body (610), and securing a chip card biometric sensor component according to various exemplary aspects in the receiving opening (620).

Some exemplary aspects are stated in summary below.

Exemplary aspect 1 is a chip card biometric sensor component comprising a carrier, a biometric sensor arranged on or in the carrier, a control logic, which is arranged on or in the carrier and is coupled to the biometric sensor, and at least one light-emitting means, which is arranged on or in the carrier or in an opening of the carrier and is connected to the control logic and is controllable by the latter.

Exemplary aspect 2 is a chip card biometric sensor component according to exemplary aspect 1, which furthermore has a contactless interface, which is coupled to the control logic and is configured for contactless communication.

Exemplary aspect 3 is a chip card biometric sensor component according to exemplary aspect 1 or 2, wherein the biometric sensor is a fingerprint sensor.

Exemplary aspect 4 is a chip card biometric sensor component according to one of exemplary aspects 1 to 3, wherein the at least one light-emitting means includes a light-emitting diode.

Exemplary aspect 5 is a chip card biometric sensor component according to one of exemplary aspects 1 to 4, wherein the carrier is a carrier strip.

Exemplary aspect 6 is a chip card biometric sensor component according to one of exemplary aspects 1 to 5, which furthermore has ISO 7816 contact surfaces for contact-based communication.

Exemplary aspect 7 is a chip card biometric sensor component according to one of exemplary aspects 1 to 6, wherein the control logic is configured to support by means of the at least one light-emitting means an authentication process performable by means of the biometric sensor.

Exemplary aspect 8 is a chip card having a chip card body and a chip card biometric sensor component according to one of exemplary aspects 1 to 7, which is embedded in the chip card body.

Exemplary aspect 9 is a chip card according to exemplary aspect 8, which furthermore has a booster antenna formed in the chip card body and an antenna formed in the chip card biometric sensor component, wherein the booster antenna and the antenna are configured for coupling to one another.

Exemplary aspect 10 is a method for forming a chip card biometric sensor component. The method comprises arranging a biometric sensor on or in a carrier, arranging a control logic on or in the carrier, coupling the biometric sensor to the control logic, arranging at least one light-emitting means on the carrier or in an opening of the carrier, and connecting the light-emitting means to the control logic, so that the light-emitting means is controllable by the control logic.

Exemplary aspect 11 is a method according to exemplary aspect 10, which furthermore has a contactless interface, which is coupled to the control logic and is configured for contactless communication.

Exemplary aspect 12 is a method according to exemplary aspect 10 or 11, wherein the biometric sensor is a fingerprint sensor.

Exemplary aspect 13 is a method according to one of exemplary aspects 10 to 12, wherein the at least one light-emitting means includes a light-emitting diode.

Exemplary aspect 14 is a method according to one of exemplary aspects 10 to 13, wherein the carrier is a carrier strip.

Exemplary aspect 15 is a method according to one of exemplary aspects 10 to 14, which furthermore comprises forming ISO 7816 contact surfaces for contact-based communication.

Exemplary aspect 16 is a method according to one of exemplary aspects 10 to 15, further comprising:

performing an authentication process by means of the biometric sensor; and

supporting the authentication process by means of the at least one light-emitting means.

Exemplary aspect 17 is a method for forming a chip card. The method comprises forming a receiving opening in a chip card body, and securing a chip card biometric sensor component according to one of exemplary aspects 1 to 7 in the receiving opening.

Further advantageous configurations of the apparatus emerge from the description of the method and vice versa.

1. A chip card biometric sensor component, comprising:
a carrier;
a biometric sensor arranged on or in the carrier;
a control logic, which is arranged on or in the carrier and is coupled to the biometric sensor; and
at least one light-emitter, which is arranged on or in the carrier or in an opening of the carrier and is connected to and controllable by the control logic.

2. The chip card biometric sensor component as claimed in claim 1, further comprising:
a contactless interface, which is coupled to the control logic and is configured for contactless communication.

3. The chip card biometric sensor component as claimed in claim 1, wherein the biometric sensor is a fingerprint sensor.

4. The chip card biometric sensor component as claimed in claim 1, wherein the at least one light-emitter includes a light-emitting diode.

5. The chip card biometric sensor component as claimed in claim 1, wherein the carrier is a carrier strip.

6. The chip card biometric sensor component as claimed in claim 1, further comprising:
ISO 7816 contact surfaces for contact-based communication.

7. The chip card biometric sensor component as claimed in claim 1, wherein the control logic is configured to support by the at least one light-emitter an authentication process performable by the biometric sensor.

8. A chip card, comprising:
a chip card body; and
a chip card biometric sensor component as claimed in claim 1, which is embedded in the chip card body.

9. The chip card as claimed in claim 8, further comprising:
a booster antenna formed in the chip card body; and
an antenna formed in the chip card biometric sensor component,
wherein the booster antenna and the antenna are configured for coupling to one another.

10. A method for forming a chip card biometric sensor component, the method comprising:
arranging a biometric sensor on or in a carrier;
arranging a control logic on or in the carrier;
coupling the biometric sensor to the control logic;
arranging at least one light-emitter on the carrier or in an opening of the carrier; and
connecting the light-emitter to the control logic such that the light-emitter is controllable by the control logic.

11. A method for forming a chip card, the method comprising:
forming a receiving opening in a chip card body; and
securing, in the receiving opening, a chip card biometric sensor having:
a carrier;
a biometric sensor arranged on or in the carrier;
a control logic, which is arranged on or in the carrier and is coupled to the biometric sensor; and
at least one light-emitter, which is arranged on or in the carrier or in an opening of the carrier and is connected to and controllable by the control logic.
